(19) United States
(12) Patent Application Publication
(10) Pub. No.: US 2002/0014391 A1
(43) Pub. Date: Feb. 7, 2002

(54) Restorable sand or pellet pile amusement device

(76) Inventor: William I. Brobeck, Moraga, CA (US)

Correspondence Address: Bruce H. Johnsonbaugh, Eckhoff, Hoppe, Slick, Mitchell & Anderson, Suite 3125, 333 Market Street, San Francisco, CA, 94105, US

(21) Appl. No.: 09/861,042

(22) Filed: May 17, 2001

Related U.S. Application Data
(60) Provisional application No. 60/205,618, filed on May 18, 2000.

(51) Int. Cl. B65G 65/34

(52) U.S. Cl. 198/550.6

(57) ABSTRACT

A restorable sand or pellet pile is provided for use as an amusement device. A sand or pellet collection chamber has inclined side walls that converge toward each other in a downward direction and having a bottom surface connected to the side walls to form a collection chamber. A support deck is mounted on top of the side walls of the collection chamber and is adapted to support sand on its upper surface. A safety grating is formed around the perimeter of the support deck to allow sand or pellets to flow downwardly therethrough into the collection chamber as children play on the pile. A diaphragm pump is positioned in the collection chamber and pumps sand upwardly through a vertically extending conduit to restore the pile. The pump may be operated intermittently or continuously. Other pumping mechanisms may be used.

### CROSS-REFERENCE TO RELATED APPLICATION

This application claims the benefit of and priority from U.S. provisional application Serial No. 60/205,618 filed May 18, 2000.

### BACKGROUND AND SUMMARY OF INVENTION

The present invention relates generally to amusement devices. More particularly, the present invention provides in one embodiment a restorable sand pile for use by children in which the sand is automatically collected as the pile becomes worn down and expands outwardly. The outwardly expanding sand drops downwardly through a perimeter grating and into a collection hopper. A pumping system periodically or continuously restores the sand pile to a conical shape. The present invention is capable of using materials other than sand for a restorable pile for use as an amusement device.

Various devices are known in the prior art for conveying and lifting sand and other similar particulate materials that behave similar to a fluid. For example, U.S. Pat. No. 4,343,394 to Emmert et al teaches an apparatus for elevating fluent materials such as grain, sand or concrete onto a conveyor. The device utilizes a vertical auger working in conjunction with an elevated conveyor. There is no teaching or suggestion in Emmert of creating a rebuildable or restorable pile for use as an amusement device. The Carroll U.S. Pat. No. 4,887,400 teaches a granular material storage system. This system utilizes a rather complex mechanism for creating a conical storage pile for grain. This patent does not teach or suggest reconstituting a conical pile of materials for use as an amusement device. The Cipriani U.S. Pat. No. 5,967,704 teaches a pneumatic system for conveying granular material. Again, this patent does not teach or suggest a restorable conical pile of fluent material which is usable as an amusement device.

The present invention provides for the first time a sand or pellet pile for use as an amusement device which, in its preferred form, is automatically restorable. The present invention provides a system which can also be transportable to a site, such as a birthday party or other special occasion, in which a sand or pellet pile would be an attraction. The present invention includes a variety of built-in safety mechanisms and a relatively simple but, yet, rugged design capable of withstanding intensive use by children. Applicant believes this is the first mechanism ever for providing a mechanically and/or automatically restorable sand or pellet pile for use by children of all ages as an amusement device.

A primary object of the invention is to provide an amusement device wherein a sand pile or pellet pile is automatically or mechanically restorable to a conical shape and which allows continuous use by children.

A further object of the invention is to provide a conical pile of fluent material, such as sand or pellets, for use as an amusement device which is automatically restorable to a conical shape.

Another object of the invention is to provide a simple but rugged design for a restorable sand pile, for example, capable of withstanding continuous use by children.

Yet another object of the invention is to provide a transportable amusement device which includes an automatically or mechanically restorable conical pile of sand or other fluent material.

Other objects and advantages of the invention will become apparent from the following description and the drawings wherein:

### BRIEF DESCRIPTION OF THE DRAWINGS

FIG. 1 is a schematic representation showing the present invention and a conical pile of sand or other fluent material available for use by children as an amusement device;

FIG. 2 is a schematic representation of the device of FIG. 1 showing how the conical pile tends to expand outwardly and wherein the outermost region of sand falls through a perimeter grating and into the collection hopper or cavity;

FIG. 3 is a schematic representation of the device of FIGS. 1 and 2 showing the pile at its lowermost size and wherein most of the sand or other fluent material has been collected in the collection hopper or cavity;

FIG. 4 is a schematic representation of the device of FIGS. 1-3 showing the sand being pumped upwardly by a diaphragm pump through a central conduit and wherein the conical pile is in the process of being restored;

FIG. 5 is a schematic representation of the device of FIGS. 1-4 showing a continuation of restoration of the pile and wherein most of the fluent material collected in the hopper has been pumped upwardly and the conical pile has been restored to its fullest height;

FIG. 6 is an exploded cross-sectional view of a portion of FIG. 1 showing in greater detail the perimeter collection grating;

FIG. 7 is a plan view on the lines 7-7 of FIG. 1 showing the sand support deck and the perimeter grating;

FIG. 8 is a sectional view showing in greater detail the region circled in FIG. 1 which includes the diaphragm pump and the check valve; and

FIG. 9 is a plan view of the support deck with an alternate pattern of drain openings.

### DETAILED DESCRIPTION OF THE DRAWINGS

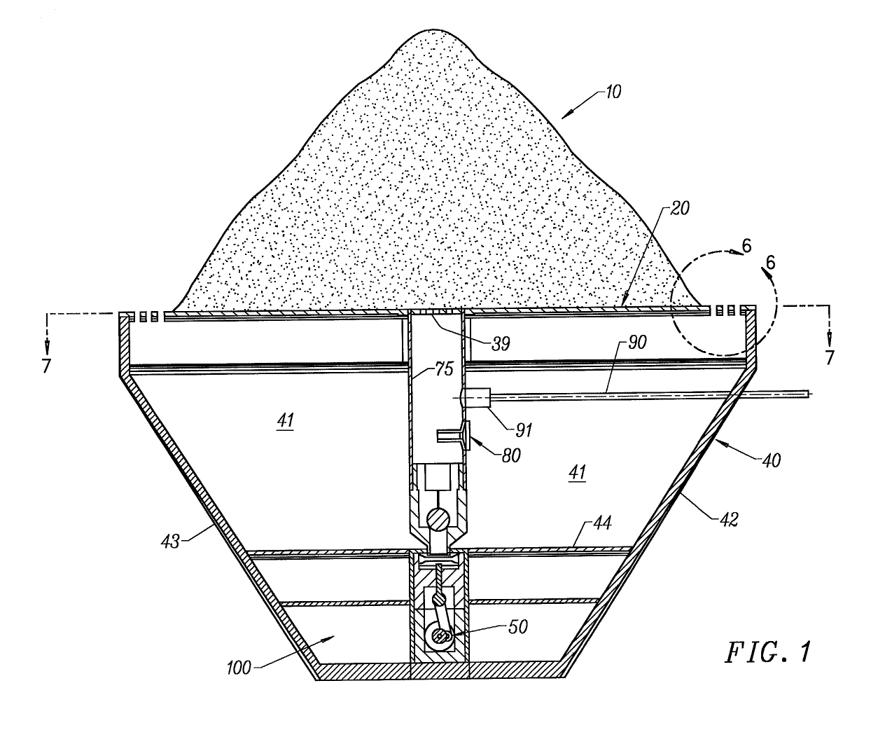

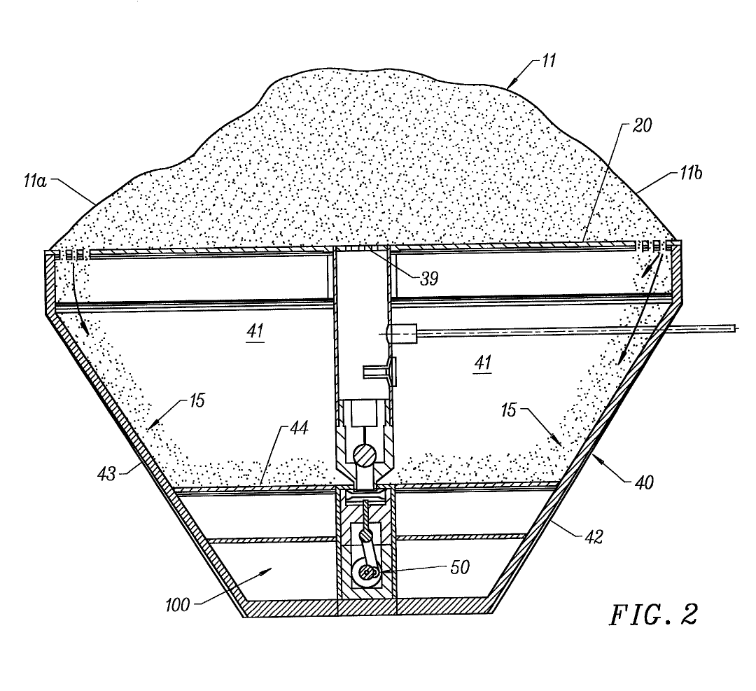

FIGS. 1-5 are schematic representations showing one manner of operation of the present invention in which a sand pile 10 is positioned on a circular support deck 20. FIG. 2 illustrates schematically how children playing on the sand pile reduce the size of the sand pile to that shown as 11 in FIG. 2 wherein the sides of the sand pile 11a and 11b extend radially outwardly from the center of the pile and flow through an open grating 30 formed in deck 20 as described in greater detail below. The sand passing through grating 30 begins to accumulate in sand cavity 41 beneath support deck 20. The accumulating sand in cavity 41 is illustrated as 15. Sand cavity 41 is formed by a collection hopper 40 having tapered side walls 42 and 43 and a flat bottom 44 as shown in FIG. 2. Side walls 42 and 43 converge toward each other in a downward direction. In the embodiment illustrated in FIGS. 1-5, the configuration of hopper 40 is an inverted, truncated cone having walls 42 and 43 and bottom horizontal sand cavity floor 44. A separate and lower chamber 100 is formed below sand cavity floor 44 which houses a diaphragm pump 50 described in greater detail below.

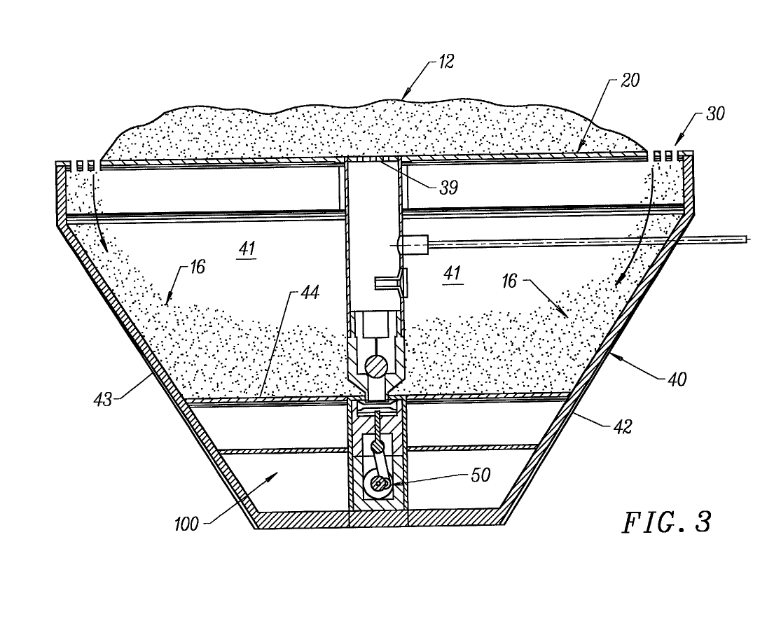

As shown in FIG. 3, the sand pile has been reduced to its smallest configuration 12 on top of support deck 20 and the sand collected within sand collection cavity 41 has increased to its maximum volume illustrated as 16.

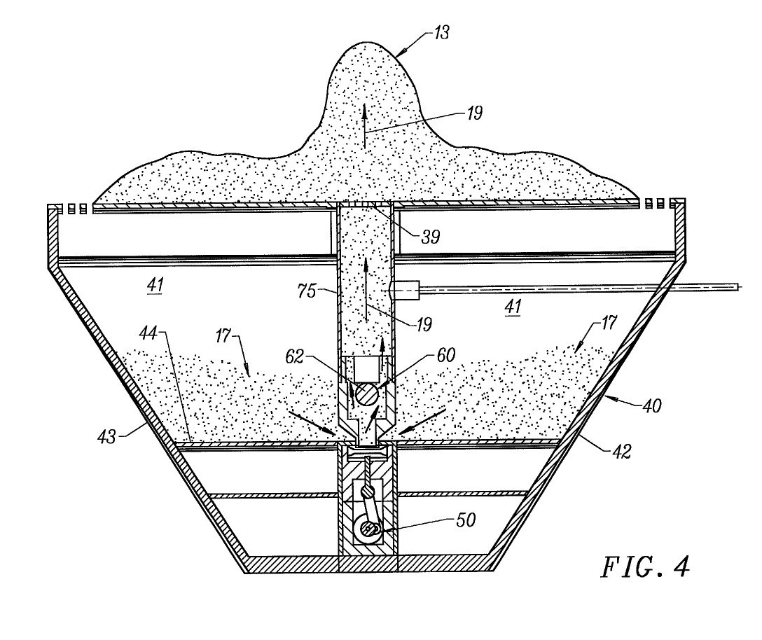

As shown in FIG. 4, diaphragm pump 50 has been actuated and ball valve 60 is shown with ball 62 in its open position in which sand from sand cavity 41 is pumped upwardly as shown by arrows 19 to begin restoring the sand pile which is shown in FIG. 4 as partially restored sand pile 13.

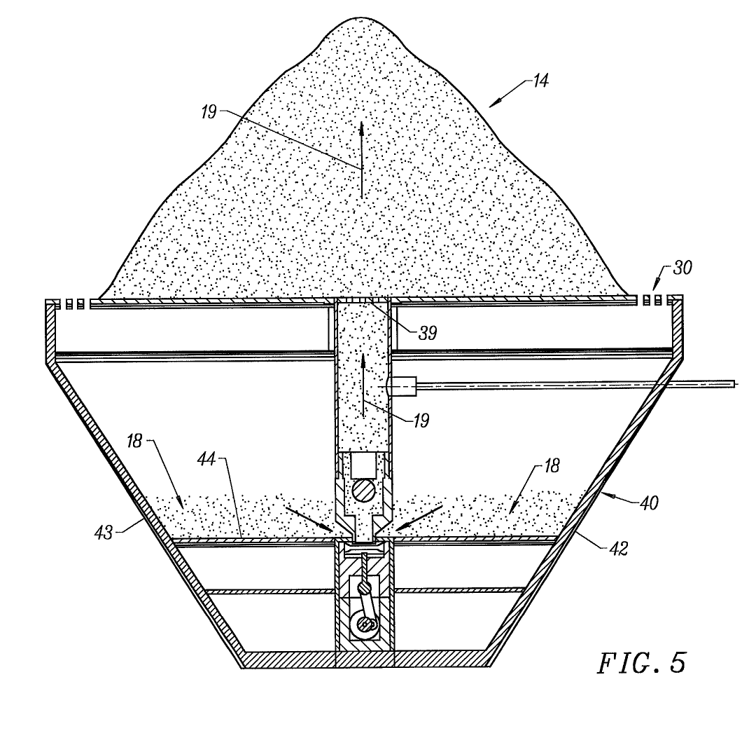

FIG. 5 illustrates the sand pile 14 as it approaches its fully restored position illustrated in FIG. 1. The general path of sand pumped upwardly by diaphragm pump 50 is shown by arrows 19. Once the sand pile has been restored to its original conical form shown in FIG. 1, diaphragm pump automatically shuts down and the cycle repeats itself. Although FIGS. 1-5 show an intermittent operation of diaphragm pump 50, it is also within the scope of the invention to allow the diaphragm pump 50 or other pump to operate continuously. For example, a vertical auger or other pumping mechanism could be utilized to restore the pile. The intermittent operation illustrated in FIGS. 1-5 is simply an example of one mode of operation of the invention. It is also within the scope of the invention to utilize an “on demand” pump which becomes automatically activated when sand or other fluent material reaches a predetermined level in sand collection cavity 41.

The present invention is not limited to using sand. Other fluent materials such as plastic pellets, gravel or any particulate matter that behaves like a liquid may be utilized. The word “pellets” is used herein and in the claims in its broadest possible sense.

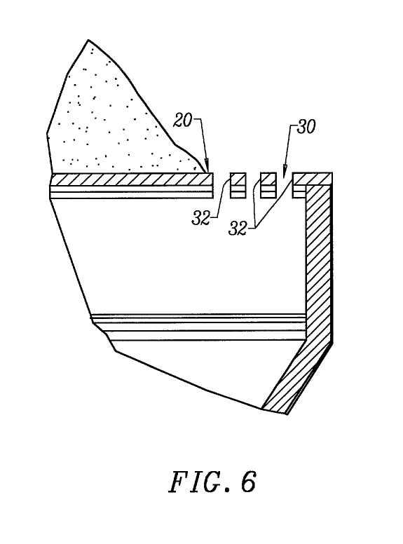

FIG. 6 shows in greater detail how the slotted openings 32 of safety grating 30 allow sand or other fluent material to flow through perimeter grating 30 formed in support deck 20. The safety grating 30 is designed to allow sand or pellets to flow freely therethrough but also to prevent children from being able to reach through the grating or lift up the grating.

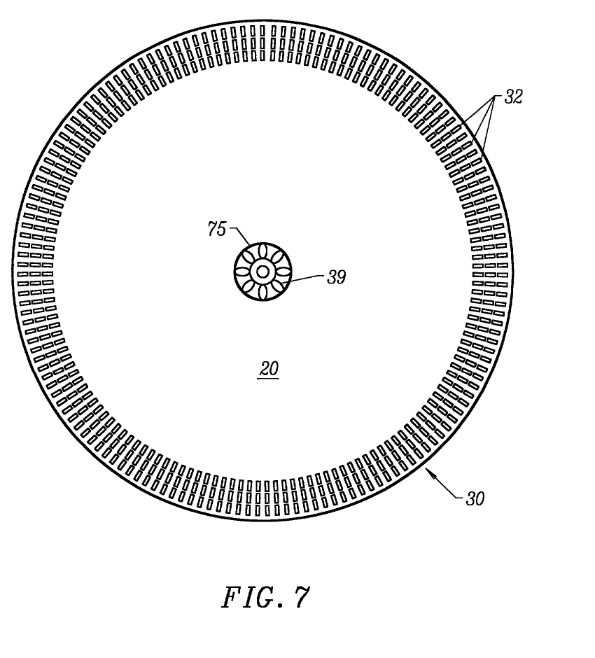

FIG. 7 is a plan view of support deck 20 and the perimeter safety grating 30 formed in deck 20. Perimeter grating 30 has a plurality of slotted openings 32 formed therein to allow sand or other fluent material to flow therethrough and into the sand collection cavity 41. FIG. 7 also illustrates the central vertical conduit 75 through which sand is pumped by diaphragm pump 50 upwardly through an opening in the center of deck 20. The top of conduit 75 is a circular section of safety grating 39.

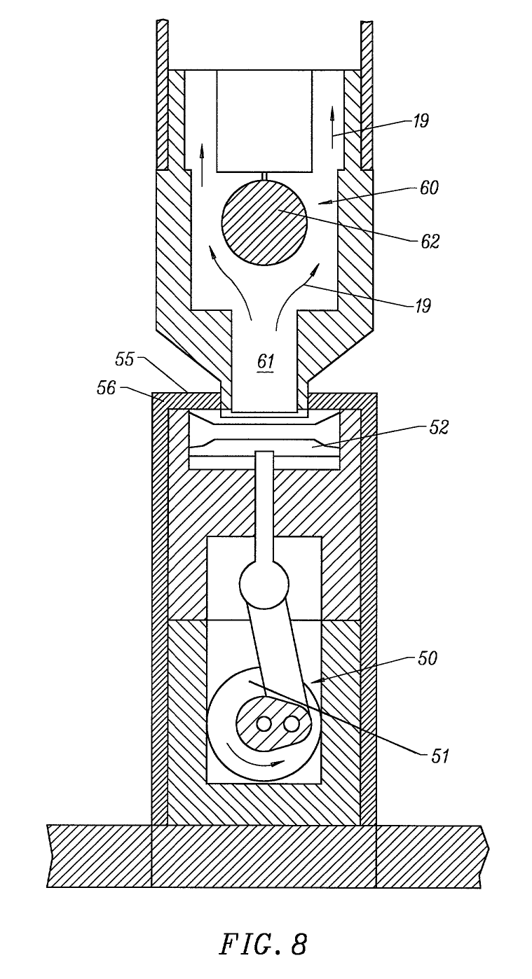

FIG. 8 illustrates diaphragm pump 50 which includes an eccentric drive arm 51 which causes oscillation of diaphragm member 52. As diaphragm member 52 moves upwardly, it forces sand into passageway 61, causing ball valve 60 to open by ball 62 moving upwardly, allowing sand to move upwardly through conduit 75 as shown by arrows 19. Diaphragm pump 50 has a sand inlet 55 which cooperates with a circular flap one way check valve 56 to allow sand into the pumping chamber as the diaphragm 52 moves downwardly. Check valve 56 closes the sand inlet 55 as diaphragm 52 is driven upwardly, preventing sand from being pumped back into the sand collection cavity 41.

FIG. 1 illustrates a moisture sensor 80 positioned in vertical conduit 75. The purpose of moisture sensor 80 is to detect the moistness of sand being pumped upwardly by diaphragm pump 50. If the sand is too dry and its moisture level falls below a predetermined level, a water supply tube 90 having a control valve 91 is actuated and water is introduced into conduit 75 through the water feed tubing 90 to moisten the sand, to reduce the friction caused between the sand and conduit 75 as well as to reduce dust formation. Moistening the sand in this fashion reduces the load on diaphragm pump 50.

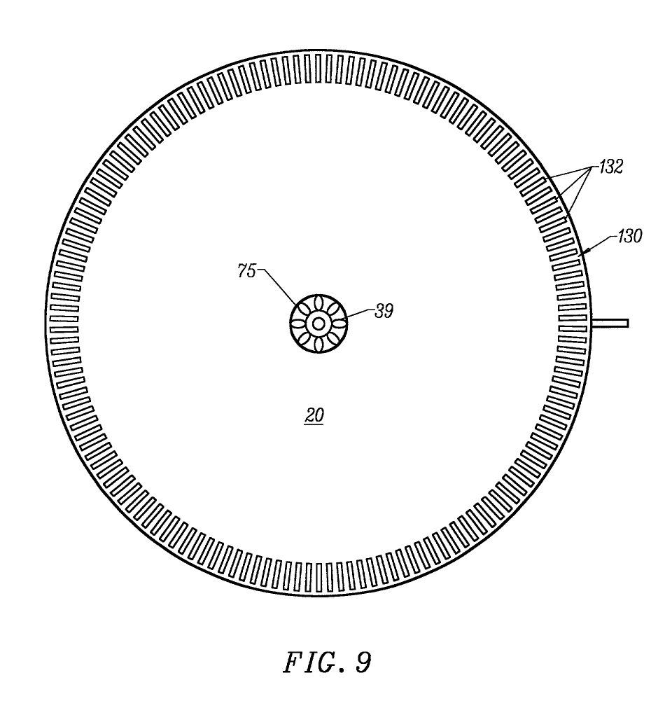

FIG. 9 illustrates deck 20 having an alternate design of slots 132 formed therein. Slots 132 are each single, radially extending, elongated slots formed around the periphery of deck 20.

It is within the scope of the invention to mount the apparatus on a trailer or a truck chassis so that the device is readily transportable to birthday parties and other similar functions where an amusement device is desirable.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. A restorable sand or pellet pile usable as an amusement device, comprising:
a sand or pellet collection chamber having inclined side walls that converge toward each other in a downward direction, a bottom surface connected to said inclined side walls, said inclined side walls and said bottom surface forming a collection chamber,
a support deck for sand or pellets carried by said side walls of said collection chamber,
a safety grating formed around the perimeter of said support deck adapted to allow sand or pellets to flow downwardly therethrough into said collection chamber, and
pump means for pumping sand or pellets upwardly from said collection chamber onto said support deck.

2. The apparatus of claim 1 wherein said pump means comprises a diaphragm pump and check valve.

3. The apparatus of claim 2 further comprising a conduit extending vertically from said diaphragm pump through said support deck.

4. The apparatus of claim 1 wherein said support deck is circular and wherein said collection chamber has a truncated conical shape.

5. The apparatus of claim 4 wherein said grating comprises a plurality of elongated, radially extending slots formed near the periphery of said deck.

6. The apparatus of claim 4 further comprising a moisture sensor carried by said vertically extending conduit for sensing moisture in said sand or pellets in said conduit.

7. The apparatus of claim 6 further comprising a water supply line and water supply valve carried by said vertically extending conduit, whereby water may be added to said conduit if the moisture sensed by said sensor falls below a predetermined level.
